(19) United States
(12) Patent Application Publication
(10) Pub. No.: US 2003/0146848 A1
(43) Pub. Date: Aug. 7, 2003

(54) Pill Pal

(76) Inventor: Ritva Liisa Kohlin, Thunder Bay (CA)

Correspondence Address: Ritva-Liisa Kohlin, 75 South Junot Avenue, Thunder Bay, ON, P7B-4X6, CA

(21) Appl. No.: 10/165,806

(22) Filed: Jun. 10, 2002

(30) Foreign Application Priority Data
Feb. 7, 2002 (CA) 2,370,677

(51) Int. Cl. G08B 21/00

(52) U.S. Cl. 340/870.16; 340/573.1

(57) ABSTRACT

The patent is a small portable electronic device which operates on a twenty-four hour multiple timed alarm system reminding a person when to take their pills/medications. The necessary times for taking medications are all set manually only once being stored into a memory cell. Thereafter a beeping alarm will sound automatically at the set times each and every day and/or night. The device has a button with which to manually stop the alarm from sounding. It has a digital number display which lights up spanning from 00:01 to 24:00 minutes. There is a detachable rope or ribbon for hanging the device around the neck comfortably. It has a clasp in the back for allowing the option of attaching it to the waist of clothing. This device may be marketed as a medical aide or other such as a daily reminder or pocket secretary thus being marketed by another name.

“Pill Pal” is a small electronic device which can easily fit in a pocket or purse. It is on a ribbon which can be worn around the heck and has a clasp in the back allowing it to attach to the waist of clothing. It has digital numbers and a beeping alarm which sounds to remind the patient when to take his/her pills or other medication. It is a device which is set only once for each of the various pill times which are stored in a memory cell. Thereafter it will automatically sound each day at those times without the renewed setting of the alarm.

I personally own a pill dispenser but have trouble remembering when to take my pills. The “Pill Pal” will eliminate the worry and the constant clock watching that make pill taking a nuisance. It is a convenience for the patient and thus an aide. If this had already been invented believe me I would have bought one long ago.

The embodiment of the invention in which an exclusive property or privilege is claimed are defined as follows:

1. A small portable electronic device which reminds a person when to take their pills or other medications.

2. A device as described in claim 1, in which the device operates on a twenty-four hour multiple timed alarm system.

3. A device as described in claim 1 or 2 in which exists a memory cell for operation of the multiple alarm.

4. A device as described in claim 1,2 or 3 in which selected alarm times are set only once initially thereby programming the alarm to sound at those set times automatically each day and/or night.

5. A device as described in claim 1,2,3 or 4 in which a light will flash at the alrm time for the benefit of the blind.

6. A device as described in claim 1,2,3,4 or 5 in which there is a button to manually depress to stop the alarm from sounding.

7. A device as described in claim 1,2,3,4,5 or 6 in which there are digital numbers that light up from 00:01 to 24:00 minutes or one twenty-four hour cycle from which to select alarm times.

8. A device as described in claim 1,2,3,4,5,6 or 7 in which the multiple alarm device may be used in a non-medical situation such as a daily reminder or pocket secretary thus being renamed.

9. A device as described in claim 1,2,3,4,5,6,7 or 8 in which a detachable rope or ribbon may be secured for wearing the device around the neck comfortably.

10. A device as described in claim 1,2,3,4,5,6,7,8 or 9 in which a clasp at the back is used to attach the device to a garment waist.
